(19) United States
(12) Patent Application Publication
(10) Pub. No.: US 2013/0124577 A1
(43) Pub. Date: May 16, 2013

(54) EFFICIENT UPDATE OF A DISCOVERY LIBRARY ADAPTER BOOK

(71) Applicants: Eric E. Goodson, Durham, TX (US); William Paul Hampel, Durham, NC (US); Santiago D. Ortega, Raleigh, NC (US); Lorin E. Ullmann, Austin, TX (US)

(72) Inventors: Eric E. Goodson, Durham, TX (US); William Paul Hampel, Durham, NC (US); Santiago D. Ortega, Raleigh, NC (US); Lorin E. Ullmann, Austin, TX (US)

(73) Assignee: International Business Machines Corporation, Armonk, NY (US)

(21) Appl. No.: 13/295,355

(22) Filed: Nov. 14, 2011

(51) Int. Cl. G06F 17/30

(52) U.S. Cl. 707/803; 707/E17.009

(57) ABSTRACT

A first DLA book and a second DLA book are compared, the first DLA book being stored in a data repository and including a first set of objects constructed according to a Common Data Model (CDM) specification to represent a first set of corresponding instances of resources in the data processing environment at a first time, the second DLA book including a second set of objects constructed according to the CDM specification to represent a second set of corresponding instances of the resources in the data processing environment at a second time. Responsive to the comparing, a DLA delta book is created, the DLA delta book including a difference between the first DLA book and the second DLA book. The DLA delta book is combined with the first DLA book stored in the data repository to update the first DLA book.

### TECHNICAL FIELD

The present invention relates generally to a computer implemented method, system, and computer program product for managing information about a data processing environment's resources. Particularly, the present invention relates to a computer implemented method, system, and computer program product for efficiently updating the information about a data processing environment's resources in a Discovery Library Adapter (DLA) book based on Common Data Model (CDM).

### BACKGROUND

### Description of the Related Art

Data processing environments often include a variety of resources. Some examples of such resources (resources) are data processing system hardware, subsystems and components of the data processing system hardware, software executing on data processing systems, components, modules, products corresponding to such software, firmware, networking devices, power distribution components, heating and cooling components, redundant or spare parts inventory, and many other similar components.

Furthermore, some resources in the data processing environment are logical resources. For example, a virtual machine executing on a host computing system is a resource in a data processing environment. Similarly, a logical grouping of certain other resources can also be a resource in a data processing environment. Resources in a data processing environment can also includes or relate to services provided by software components, business functions using those services, and organizations providing those business functions.

CDM is a standardized way of defining resources and their interrelationships in a hierarchy. For example, some resources defined and related to one another according to CDM may represent another resource—a higher level resource, such as a data processing system or a platform, in the data processing environment.

CDM provides classes, attributes, and relationships to describe resources and their relationships in a data processing environment. Thus, CDM acts as the dictionary and provides grammar for consistently describing and identifying resources in a data processing environment

CDM is a canonical and conceptual data model that brings together various industry data models for resource representation. A DLA book is a compilation of resource information described and organized according to CDM. A data processing environment can include more than one DLA book describing the resources in the data processing environment. Typically, a DLA book is organizes according to Identity Markup Language (IDML) specification in Extensible Markup Language (XML). IDML uses XML to describe Configuration Items (CIs) (i.e., instances of resources available in a data processing environment) and their relationships with one another according to a given CDM.

### SUMMARY

The illustrative embodiments provide a method, system, and computer program product for updating a Discovery Library Adapter (DLA) book in a data processing environment. An embodiment compares at an application executing using a processor and a memory, a first DLA book and a second DLA book, the first DLA book being stored in a data repository and including a first set of objects constructed according to a Common Data Model (CDM) specification to represent a first set of corresponding instances of resources in the data processing environment at a first time, the second DLA book including a second set of objects constructed according to the CDM specification to represent a second set of corresponding instances of the resources in the data processing environment at a second time. The embodiment creates, responsive to the comparing, a DLA delta book, the DLA delta book including a difference between the first DLA book and the second DLA book. The embodiment combines the DLA delta book with the first DLA book stored in the data repository to update the first DLA book.

### BRIEF DESCRIPTION OF THE SEVERAL VIEWS OF THE DRAWINGS

The novel features believed characteristic of the embodiments are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a configuration of DLA books for efficient update in accordance with an illustrative embodiment;

FIG. 4A depicts an example CDM specification of two resources and corresponding example objects in an example DLA book usable in FIG. 3 in accordance with an illustrative embodiment;

FIG. 4B depicts another example DLA book depicting a naming rule for an application resource in accordance with an illustrative embodiment;

FIG. 4C depicts another example DLA book depicting a naming rule for a communication resource in accordance with an illustrative embodiment;

FIG. 4D depicts another example DLA book depicting a naming rule for a communication resource in accordance with an illustrative embodiment;

FIG. 5 depicts a flowchart of an example process for efficiently updating a DLA book in accordance with an illustrative embodiment;

FIG. 6 depicts a flowchart of an example process of trial matching of instance identifiers between objects in two DLA books in accordance with an illustrative embodiment; and

FIG. 7, this figure depicts a flowchart of an example process of type and naming rule matching in accordance with an illustrative embodiment.

### DETAILED DESCRIPTION

The illustrative embodiments recognize that the number of resources in a data processing environment can be staggering. Depending upon the size of the data processing environment and the granularity at which a typical DLA book identifies and describes the resources, a database can take on the order of a few days to load such a set of DLA books.

While a resource has to be uniquely described and identifiable in a DLA book, the same resource can appear in more than one DLA book, when several DLA books are used in a data processing environment. For example, a data center may manage resources allocated to each customer in a separate DLA book, but certain resources, such as a rack infrastructure that hosts several customers within, may appear in each hosted customer's DLA book.

A resource may be present in a data processing environment, but may not be available for use. When a resource is available for use, the resource is deemed to have been instantiated. An instantiated resource must appear in at least one DLA book as an object of one or more class according to CDM. A resource object (object) can appear in more than one DLA book if either the same instance of the resource is identified in more than one DLA book, or separate instances of the same resource appear in different DLA books.

Within the scope of this disclosure, when the disclosure makes a reference to a resource appearing in a DLA book, the DLA book includes information about an instance of the resource. Within the scope of this disclosure, when the disclosure makes a reference to a resource in a data processing environment, the reference can be to the resource or to an instance thereof depending upon the implementation.

Regardless of how many DLA books a resource appears in, and regardless of how resources are identified within a DLA book, the resource has to be uniquely identifiable in the data processing environment. In other words, a resource can appear in two DLA books, having an identifier (instance identifier) that is different in each of the two DLA books but pointing back to the same resource in the data processing environment. This is not to say that the same resource cannot be identified using similar instance identifiers in multiple DLA books under certain circumstances.

A resource in a data processing environment is identified with an identifier (name, or resource identifier) that is constructed according to a set of naming rules. A naming rule is a specification or logic for constructing a resource identifier in a given data processing environment.

In one embodiment, a naming rule can specify a subset of attributes of a resource's object that, organized in some order, form the name. For example, an object may be

<cdm:sys.zOS.ZSeriesComputerSystem id=“1-LPART1-VCSLPAR” sourceToken=“1-LPART1-VCSLPAR”> <cdm:ModelID>710</cdm:ModelID> <cdm:Model>2097</cdm:Model> <cdm:SerialNumber>000000000006C362</cdm:SerialNumber> <cdm:ProcessingCapacity>875</cdm:ProcessingCapacity> <cdm:Manufacturer>IBM</cdm:Manufacturer> </cdm:sys.zOS.ZSeriesComputerSystem>

The instance identifier of this example object is “1-LPART1-VCSLPAR” and is identified by the “id” attribute. A naming rule may specify that (manufacturer, model, serial number) form the name of the resource. Accordingly, instance identifier “1-LPART1-VCSLPAR” references a resource of the name that includes “IBM”, “2097”, and “000000000006C362”.

Thus, a resource can be identified in a data processing environment using a corresponding resource identifier that is constructed using a naming rule for the data processing environment. A resource identifier can follow more than one naming rule. A single resource identifier associated with a resource may comply with multiple naming rules, or the resource may be associated with multiple resource identifiers, each constructed according to a different naming rule, and each unique within the data processing environment. In an embodiment, an instance identifier can also be constructed to comply with one or more naming rules in a similar manner.

The illustrative embodiments recognize that resources availability in a data processing environment can change from time to time. Furthermore, instances of the resources available in the data processing environment can also change from time to time. Therefore, the DLA books in use in the data processing environment are updated from time to time, to reflect a snapshot view of the resource instances available in the data processing environment at a given time.

The illustrative embodiments recognize that given the volume of information in a typical DLA book, updating a previous version of a DLA book that is already loaded in a database with a later version of the DLA book is computationally intensive and time consuming task. A presently used method for updating a DLA book compares each object in the previous version with each object in the later version of the DLA book, identifies the differences, and makes the corresponding changes to the already loaded DLA book.

Such a method of update is called a single-dimensional update. The illustrative embodiments recognize that a single-dimensional update is computationally intensive and time consuming for updating typically sized DLA books.

The illustrative embodiments used to describe the invention generally address and solve the above-described problems and other problems related to updating DLA books in a data processing environment. The illustrative embodiments provide a method, system, and computer program product for efficient update of a Discovery Library Adapter book in a data processing environment.

Generally, the illustrative embodiments provide a multi-dimensional method of updating a DLA book. In one dimension of the multi-dimensional method, an embodiment leverages the recognition that even when objects corresponding to a resource appear in different DLA books, and particularly when an object of the same resource appears in previous and later versions of the same DLA book, the object can include a common instance identifier. Thus, an embodiment can reduce the set of objects to be compared between the previous version and the later version of the DLA book, by locating those objects in the two versions whose instance identifiers match. The subset of objects bearing matching instance identifiers can be compared separately, and the differences recorded in a DLA delta book.

A DLA delta book according to an embodiment is a collection of differences between two DLA books (different DLA books, or different versions of the same DLA book). A DLA delta book when combined with one of the two DLA books yields the other of the two DLA books. In other words, when one of the two DLA books participating in the DLA delta book creation is combined with the DLA delta book, the DLA book is updated to the second of the two DLA books participating in the DLA delta book creation.

An embodiment updates the remaining objects in the set of objects to be compared using two other dimensions of update. The embodiment selects a type information associated with an object and a set of naming rules used to name the resource to further reduce the comparison of objects in the remaining set of objects. Comparing the objects in two DLA books, an embodiment efficiently creates the DLA delta book, which can then be applied to a DLA book already loaded in the database, or any suitable data repository, to achieve an efficient update of the DLA book.

The illustrative embodiments are described with respect to certain components or resources only as examples. Such descriptions are not intended to be limiting on the illustrative embodiments. For example, an illustrative embodiment described with respect to a computing hardware resource can be implemented with respect to a data storage component, networking component, peripherals, or software resources within the scope of the illustrative embodiments.

Similarly, the illustrative embodiments are described with respect to certain identifiers, names, and objects only as examples. Such descriptions are not intended to be limiting on the illustrative embodiments. For example, an illustrative embodiment described with respect to one instance identifier format can be implemented using a different manner of identifying the objects corresponding to resource instances within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are further described with respect to certain applications only as examples. Such descriptions are not intended to be limiting on the invention. An embodiment of the invention may be implemented with respect to any type of application, such as, for example, applications that are served, the instances of any type of server application, a platform application, a stand-alone application, an administration application, or a combination thereof.

An application, including an application implementing all or part of an embodiment, may be implemented in any suitable language or platform such as Java®, C++, or Object Resource Broker (ORB) programming model (e.g. CORBA). An application, including an application implementing all or part of an embodiment, may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which the invention may be implemented. (Java and all Java-based trademarks and logos are trademarks or registered trademarks of Oracle and/or its affiliates).

An illustrative embodiment may be implemented in hardware, software, or a combination thereof. An illustrative embodiment may further be implemented with respect to any type of data storage resource, such as a physical or virtual data storage device, that may be available in a given data processing system configuration.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

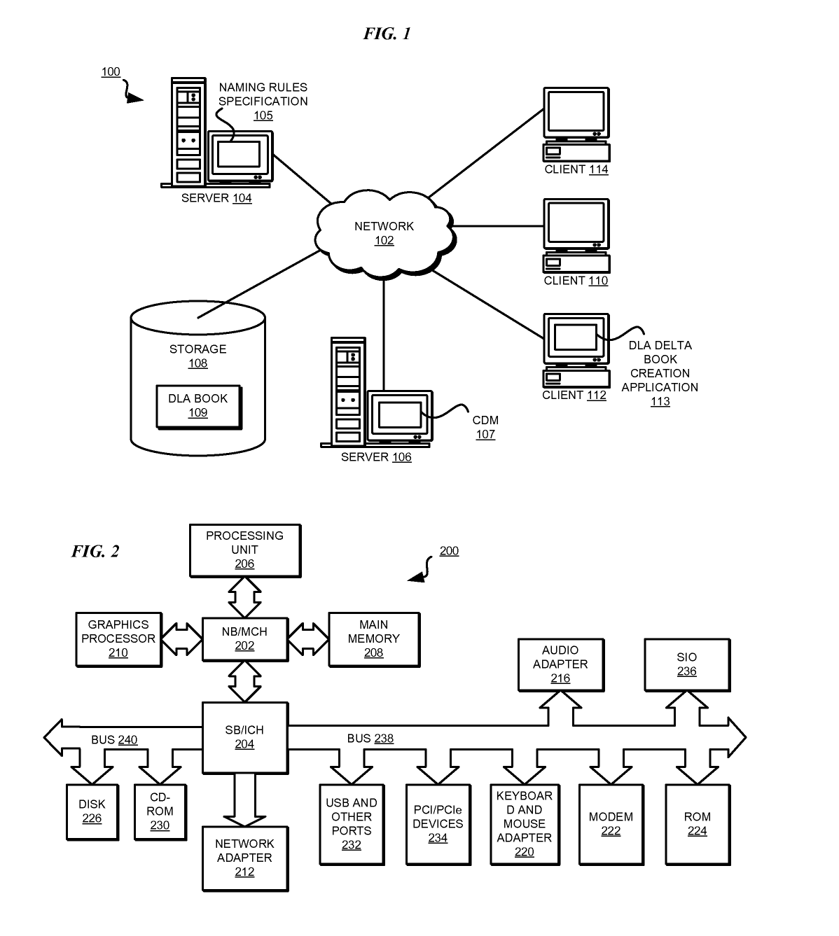

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

A data processing system, such as server 106 may include CDM specification 107 based on which DLA book 109 may be created and stored in storage 108. DLA delta book creation application 113 may implement an embodiment of the invention described herein to update DLA book 109.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

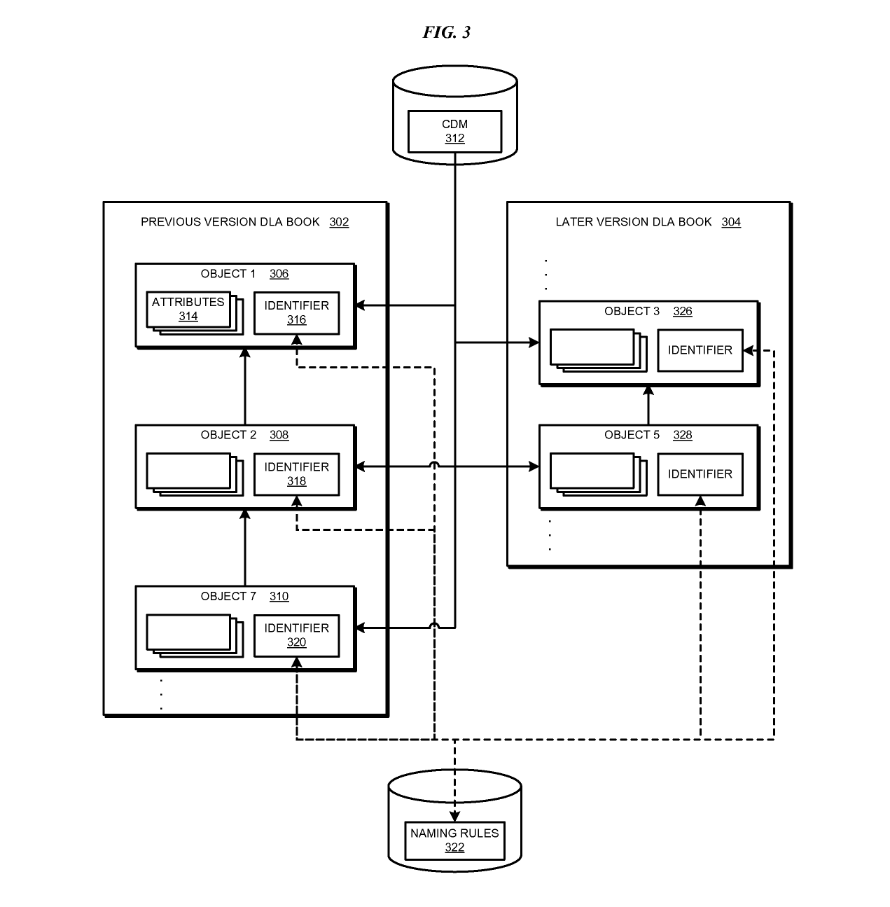

With reference to FIG. 3, this figure depicts a block diagram of a configuration of DLA books for efficient update in accordance with an illustrative embodiment. DLA book 302 is a DLA book that has to be updated according to an embodiment. As an example, in one embodiment, DLA book 302 is a previous version of a DLA book that is already loaded in a database, such as DLA book 109 in storage 108 in FIG. 1.

DLA book 304 is another DLA book using which, DLA book 302 has to be updated. In an embodiment, DLA book 304 is a later version of DLA book 302.

As an example to illustrate the operation of an embodiment, DLA book 302 includes objects 306, 308, and 310. Objects 306, 308, and 310 are objects according to certain classes specified in CDM, such as CDM 312, which may be implemented using CDM 107 in FIG. 1. Furthermore, objects 306, 308, and 310 represent instances of certain resources in the data processing environment to which DLA book 302 pertains.

According to the depicted example, objects 306, 308, and 310 are related to one another and are organized in a hierarchy. Object 308 is a child object of object 306, and a parent of object 310. For example, object 306 may represent an instance of an operating system on a data processing system, object 308 may represent a database application executing there under, and object 310 may represent a backup job associated with the database.

An object, such as object 306 further includes a set of attributes, such as attributes 314. Attributes 314 may vary depending upon the class(es) instantiated for a given object. Objects 308 and 310 may also include sets of attributes in a similar manner.

Each object 306, 308, and 310 includes at least one corresponding instance identifier, namely, 316, 318, and 320, respectively. Instance identifiers 316, 318, and 320 are formed in compliance with one or more naming rules 322.

DLA book 304 is a DLA book from which an embodiment identifies changes, creates a DLA delta book (not shown), and applies to DLA book 302 to update DLA book 302. In the example configuration depicted in FIG. 3, DLA book 304 includes objects 326 and 328. Objects 326 and 328 may appear anywhere in DLA book 304 without limitation, including the same positions as the positions of objects 316 and 318 in DLA book 302. Instance identifiers 336 and 338 are configured using naming rules 322 as described earlier. Objects 326 and 328 further include corresponding sets of attributes.

As an example, assume that DLA book 304 is a later version of DLA book 302, which is a previous version of a DLA book in use in a given data processing environment. Further assume that object 326 corresponds to the same resource as object 316, and object 328 corresponds to the same resource as object 318. An object corresponding to object 320 is absent in DLA book 304.

Further assume that the attributes of object 326 are different in some respect from attributes of object 316, and attributes of object 328 are different in some respect from attributes of object 318. For example, object 326 may include an additional attribute as compared to the attributes in object 316. As another example, object 326 may include an attribute having a different value as compared to the same attribute in object 316. As another example, attributes of object 328 may not include an attribute present in object 318.

An embodiment described herein compares the objects in DLA books 302 and 304 and identifies the differences in the two DLA books in an efficient manner as compared to the prior art. An embodiment further creates a DLA delta book and applies the contents of the DLA delta book as an update to DLA book 302 such that updated DLA book 302 matches DLA book 304.

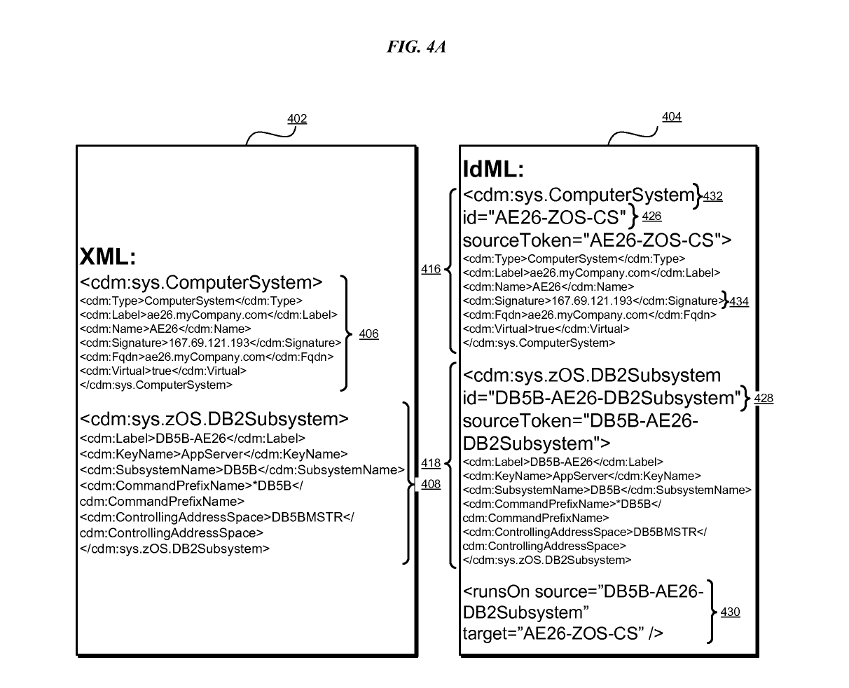

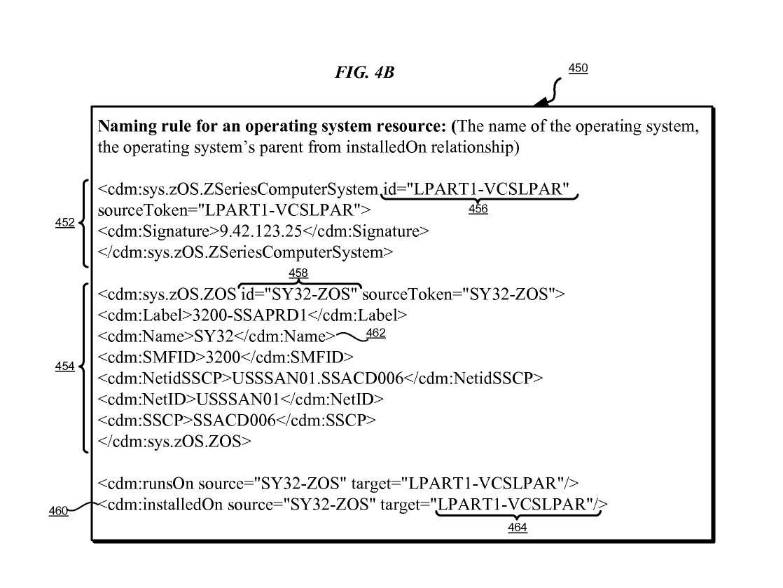

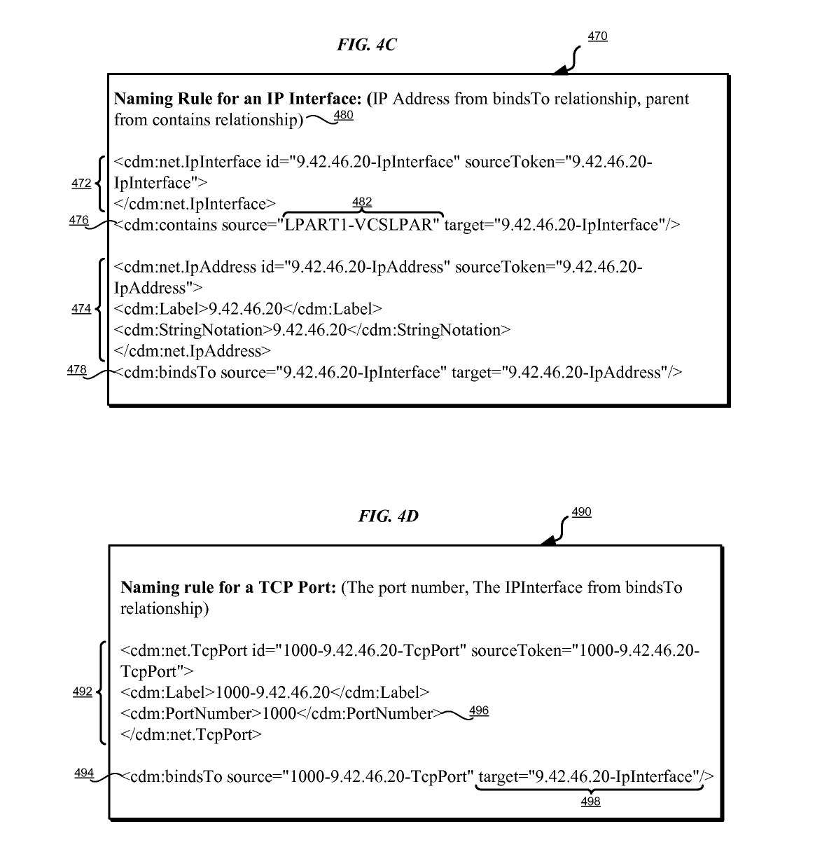

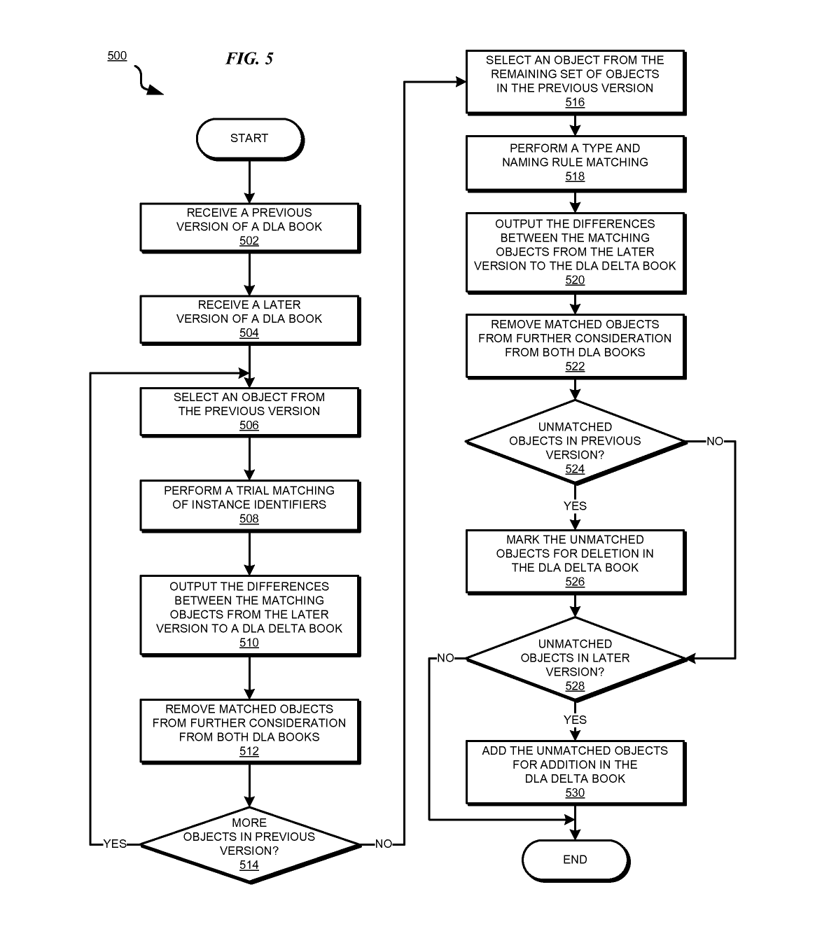

With reference to FIG. 4A, this figure depicts an example CDM specification of two resources and corresponding example objects in an example DLA book usable in FIG. 3 in accordance with an illustrative embodiment. CDM 402 is usable as CDM 312 in FIG. 3. FIG. 4A further highlights certain differences between a standard XML document and an IDML document as used in a DLA book. DLA book 404 is usable as DLA book 302 or DLA book 304 in FIG. 3.

As an example, CDM 402 specifies resource attributes 406 for an example computer system resource and resource attributes 408 for an example subsystem resource. DLA book 404 depicts object 416 that includes resource attributes 406 for an actual instance of a computer system that is available or in use. Object 418 that includes resource attributes 408 for an actual instance of a database subsystem that is available or in use on the system of object 416.

Instance identifier 426 identifies the instance of object 416 and instance identifier 428 identifies the instance of object 418. Relationship identifier 430 indicates that object 418 is related to object 416 in a “runsOn” relationship, to indicate that the database instance of object 418 is executing on the computer system instance of object 416. Relationship 430 identifies object 416 to which object 418 is related by referencing identifiers 426 and 428 in relationship 430 as shown in the example depiction.

An instance within a DLA book, such as instance 416 in DLA book 404 includes type of object 432, and a set of attributes with corresponding values, such as attribute 434 and a corresponding value of attribute 434.

As different from a standard XML document, an IDML document, such as DLA book 404, includes instance identifiers, such as instance identifiers 426 and 428. Further as different from a standard XML document, an IDML document, such as DLA book 404, also includes relationships between instances, such as relationship 430 between instances 416 and 418, configured in the manner of relationship 430. Furthermore, an instance identifier in an IDML document relates to a resource identifier according to a naming rule.

For example, one naming rule may specify a subset of attributes, such as attribute 434, in instance 416 to relate instance identifier 426 with a particular resource. An example of this type of naming rule has been provided earlier in this disclosure. Many other types of naming rules are contemplated within the scope of the illustrative embodiments.

With reference to FIG. 4B, this figure depicts another example DLA book depicting a naming rule for an application resource in accordance with an illustrative embodiment. DLA book 450 includes instances 452 and 454 in a manner analogous to instances 416 and 418 in DLA book 404 in FIG. 4A.

Instance 452 represents an instance of a computer system resource and includes instance identifier 456. Instance 454 represents an instance of an operating system resource and includes instance identifier 458. Relationship 460 is an “installedOn” relationship, which indicates that the operating system instance 454 is installed on the computer system instance 452. Naming rule 462 comprises the name of the operating system, as contained in “Name” attribute 462 of instance 454, combined with parent 464 of the operating system instance, which is identified in relationship 460.

With reference to FIG. 4C, this figure depicts another example DLA book depicting a naming rule for a communication resource in accordance with an illustrative embodiment. DLA book 470 includes instances 472 and 474 in a manner analogous to instances 452 and 454 in DLA book 450 in FIG. 4B.

Instance 472 represents an instance of an IP interface resource and includes an instance identifier associated with a corresponding “id” attribute as previously described. Instance 474 represents an instance of IP address resource and includes a corresponding instance identifier. Relationship 476 is a “contains” relationship, which indicates that the IP interface of instance 472 is contained in the computer system identified in instance 452 in FIG. 4B. Relationship 478 is a “bindsTo” relationship, which indicates that the IP address of instance 474 binds to IP interface of instance 472. Naming rule 480 comprises the IP address from “bindsTo” relationship 478, combined with parent 482 identifying instance 452 in FIG. 4B.

With reference to FIG. 4D, this figure depicts another example DLA book depicting a naming rule for a communication resource in accordance with an illustrative embodiment. DLA book 490 includes instances 492 and 494 in a manner analogous to instances 472 and 474 in DLA book 470 in FIG. 4C.

Instance 492 represents an instance of TCP port resource and includes an instance identifier associated with a corresponding “id” attribute as previously described. Relationship 494 is a “bindsTo” relationship, which indicates that the TCP port of instance 492 is binds to IP interface of instance 472 in FIG. 4C. Naming rule 495 comprises the port number from attribute 496, combined with parent 498 IP interface from relationship 494.

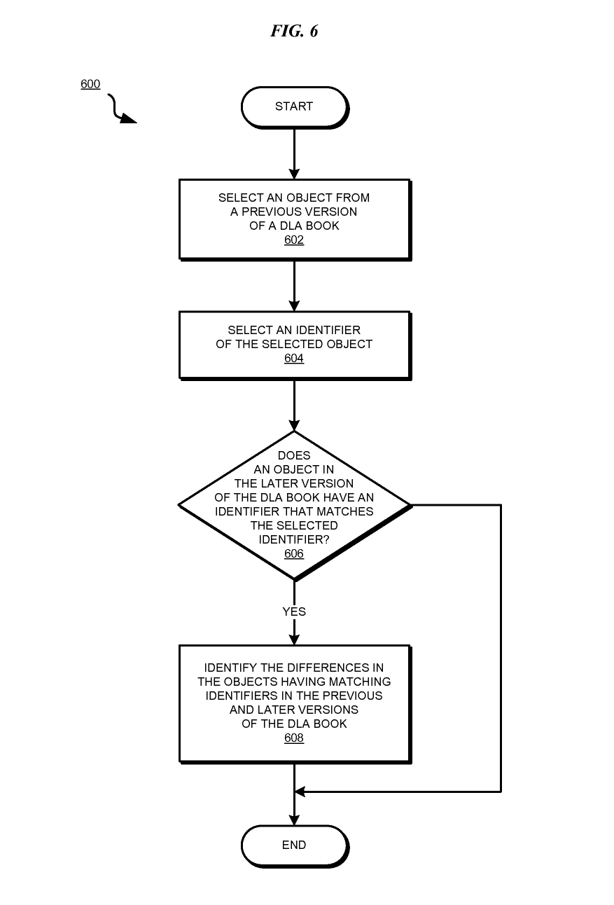

With reference to FIG. 5, this figure depicts a flowchart of an example process for efficiently updating a DLA book in accordance with an illustrative embodiment. Process 500 can be implemented in a DLA delta book creation application, such as application 113 in FIG. 1.

Process 500 begins by receiving a previous version of a DLA book, such as a version that is already loaded in a database, for example, DLA book 109 in FIG. 1, or DLA book 302 in FIG. 3 (step 502). Process 500 receives a later version of the DLA book, such as DLA book 304 in FIG. 3 (step 504).

Process 500 selects an object from the previous version of the DLA book (step 506). Process 500 performs a trial matching of instance identifiers according to an embodiment, such as by using process 600 in FIG. 6 (step 508). Essentially, in step 508, process 500 tries to determine whether an object referring to the same resource instance exists in the previous version as well as the later version of the DLA book.

In step 508, process 500 leverages the recognition of the illustrative embodiments that an object having a resource identifier constructed in an identical manner and having identical parts of the identifier represents the same instance of the same resource in the data processing environment due to the uniqueness of resource names.

In other words, if an object in the previous version of the DLA book has a resource name according to a naming rule that matches the resource name of an object in the later version of the DLA book according to the naming rule, process 500 can update that object more efficiently than the prior art by limiting the attribute-to-attribute and relationship-to-relationship matching to only one or few objects. In the prior art, such update requires performing an attribute-by-attribute matching of the object in the previous version with every object in the later version, as in a single-dimensional update of the prior art.

Process 500 outputs the differences between the objects having matching resource identifiers from the object in the later version to a DLA delta book (step 510). For example, if the object in the previous version has an attribute whose value has changed in the corresponding object in the later version, process 500 outputs the changed value from the object in the later version to the DLA delta book.

Likewise, if the object in the previous version has an attribute that has been deleted in the corresponding object in the later version, process 500 marks that attribute for deletion according to the object in the later version to the DLA delta book. As another example, if the object in the later version has a new attribute that was not present in the corresponding object in the previous version, process 500 outputs the new attribute for addition according to the object in the later version to the DLA delta book.

These example comparisons are not intended to be limiting on the illustrative embodiments. Those of ordinary skill in the art will be able to perform other similarly purposed comparisons using this disclosure and the same are contemplated within the scope of the illustrative embodiments.

Process 500 removes the matched objects from further consideration from both DLA books (step 512). In one embodiment, process 500 does not actually remove the object from a book, but simply marks the object as having been matched, so that the object can be omitted in future steps. Note that steps 510 and 512 are performed for those objects whose instance identifiers match. The instance identifiers of each object in the previous version may not match the instance identifier of an object in the later version, in which case, process 500 skips steps 510 and 512.

Process 500 determines whether more objects remain to be selected and evaluated for trial matching in a similar manner in the previous version of the DLA book (step 514). If more objects remain (“Yes” path of step 514), process 500 returns to step 506 and selects one of the remaining objects. If all objects in the previous version of the DLA book have been selected and evaluated for trial matching of step 508 (“No” path of step 514), process 500 selects an object from the remaining set of objects in the previous version (step 516).

For example, when the instance identifiers of some objects in the previous version match the instance identifiers of some of the objects in the later version, the remaining set of objects in the previous version will include those objects whose instance identifiers did not match with an instance identifier of an object in the later version. Likewise, the later version of the DLA book will also contain a remaining set of objects whose instance identifiers did not match an instance identifier of an object in the previous version.

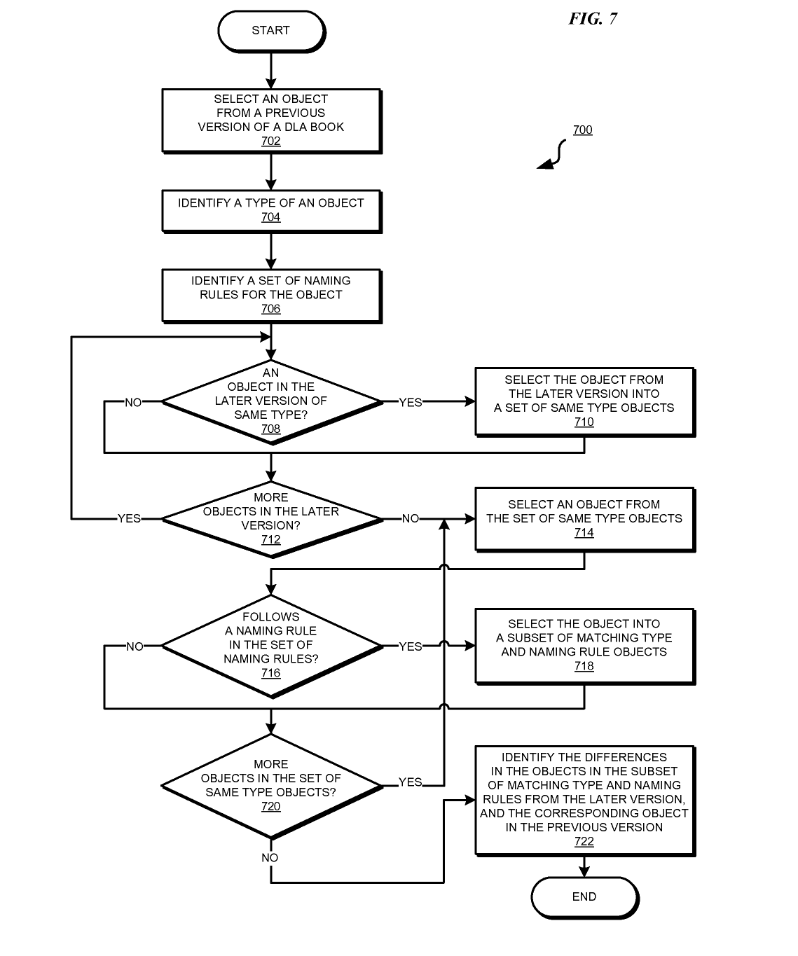

Process 500 performs a type and naming rule matching between the object selected in step 516 and an object in the remaining set of objects in the later version of the DLA book (step 518). For example, process 500 may execute process 700 in FIG. 7 at step 518.

In essence, at step 518, process 500 identifies a type of the object selected from the remaining set in the previous version. Process 500 identifies all the objects in the remaining set of objects in the later version that have the same type, forming a subset of remaining objects in the later version. Process 500 identifies the one or more naming rules that are used in the resource identifier of the object selected in step 516. Process 500 iterates through the objects in the subset to identify that subset of the subset whose member objects follow at least one common naming rule as the object selected in step 516.

Process 500 outputs the differences between the objects having matching instance identifiers from the object in the later version to a DLA delta book (step 520). Process 500 removes the matched objects from further consideration from both DLA books (step 522). Step 520 is performed in a manner similar to step 510, and step 522 is performed in a manner similar to step 512. Furthermore, steps 520 and 522 are performed in process 500 when step 518 results in at least one object from the later version where the type and a naming rule match with the object selected in step 516.

Process 500 determines whether any unmatched objects remain the previous version of the DLA book (step 524). If an unmatched object remains in the previous version after the trial matching of step 508 and the type and naming rule matching of step 518 have been performed (“Yes” path of step 524), the unmatched object from the previous version is marked for deletion in the DLA delta book (step 526).

Process 500 determines whether an unmatched object remains in the later version of the DLA book (step 528). Process 500 also reaches step 528 when no unmatched objects remain in the previous version (“No” path of step 524). If an unmatched object remains in the later version after the trial matching of step 508 and the type and naming rule matching of step 518 have been performed (“Yes” path of step 528), the unmatched object from the later version is marked for addition in the DLA delta book (step 530). Process 500 ends thereafter.

With reference to FIG. 6, this figure depicts a flowchart of an example process of trial matching of instance identifiers between objects in two DLA books in accordance with an illustrative embodiment. Process 600 can be implemented as step 508 in FIG. 5. Furthermore, process 600 can be implemented in a DLA delta book creation application, such as application 113 in FIG. 1.

Process 600 begins by selecting an object from the previous version of the DLA book (step 602). Process 600 selects an identifier from the object, such as instance identifier 426 in FIG. 4A or 456 in FIG. 4B (step 604).

Process 600 determines whether an object in the later version of the DLA book has an identifier that matches the selected identifier of step 604 (step 606). If an object in the later version of the DLA book has an identifier that matches the selected identifier of step 604 (“Yes” path of step 606), process 600 identifies the differences, if any, between the two objects, such as different attributes, different values of the attributes, different additional identifiers Including but not limited to different relationships), or a combination thereof (step 608). Process 600 ends thereafter. The identified differences are then recorded in a DLA delta book as described with respect to FIG. 5.

Process 600 is described to perform a matching based on matching the instance identifiers as an example. In one embodiment, process 600 can be modified to further confirm the matching by using the naming rules to ensure that the matched objects in fact reference the same instance of a resource in the data processing environment.

With reference to FIG. 7, this figure depicts a flowchart of an example process of type and naming rule matching in accordance with an illustrative embodiment. Process 700 can be implemented as step 518 in FIG. 5. Furthermore, process 700 can be implemented in a DLA delta book creation application, such as application 113 in FIG. 1.

Process 700 begins by selecting an object from the previous version of the DLA book (step 702). Process 700 identifies a type of the selected object (step 704).

Process 700 identifies a set of naming rules for the object, such as the set of one or more naming rules followed in the naming of the resource whose instance is represented by the object (step 706). Process 700 determines whether an object in the later version of the DLA book has a type that matches the identified type of step 704 (step 708). If an object in the later version of the DLA book has a type that matches the identified type of step 704 (“Yes” path of step 708), process 700 selects the object from the later file into a set of same type objects (step 710). If an object in the later version of the DLA book does not have a type that matches the identified type of step 704 (“No” path of step 708), process 700 proceeds to step 712.

Process 700 determines whether more objects remain in the later version of the DLA book to be evaluated according to step 708 (step 712). If more objects remain in the later version of the DLA book (“Yes” path of step 712), process 700 returns to step 708 and performs the determination of step 708 for another remaining object in the later version of the DLA book.

If no more objects remain in the later version of the DLA book (“No” path of step 712), process 700 selects an object from the set of same type objects in the later version of DLA book (step 714). Process 700 determines whether the selected object of step 714 follows at least one naming rule as the object of step 702 (step 716).

If the selected object of step 714 follows at least one naming rule as the object of step 702 (“Yes” path of step 716), process 700 selects the object into a subset of matching type and naming rule objects in the later version of the DLA book (step 718). If the selected object of step 714 does not follow at least one naming rule as the object of step 702 (“No” path of step 716), process 700 proceeds to step 720.

Process 700 determines whether more objects remain in the set of same type objects to be evaluated according to step 717 (step 720). If more objects remain the set of same type objects (“Yes” path of step 720), process 700 returns to step 716 and performs the determination of step 716 for another object in the set of same type objects. If no more objects remain in the set of same type objects (“No” path of step 720), process 700 identifies the differences between the objects in the subset of matching type and naming rule objects in the later version of the DLA book and the corresponding object selected from the previous version of the DLA book in step 702 (step 722). Process 700 ends thereafter. The identified differences are then recorded in a DLA delta book as described with respect to FIG. 5.

The changes or differences recorded in a DLA delta book from process 500, 600, or 700 in FIG. 5, 6, or 7 respectively, have to be applied to the previous version of the DLA book. Any known technique for merging the DLA delta book with the previous version of the DLA book can be used to perform efficient update of the DLA book according to the illustrative embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for efficient update of a Discovery Library Adapter book in a data processing environment. Using an embodiment of the invention, an already loaded DLA book can be updated in less time and with less computational effort as compared to the presently used DLA book update methods. Note that an IDML file usable in conjunction with an embodiment may be received from a DLA enabled data source as well as a non-DLA source, such as a sensor, a script, or a database, within the scope of the illustrative embodiments.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for updating a Discovery Library Adapter (DLA) book in a data processing environment, the method comprising:
comparing at an application executing using a processor and a memory, a first DLA book and a second DLA book, the first DLA book being stored in a data repository and including a first set of objects constructed according to a Common Data Model (CDM) specification to represent a first set of corresponding instances of resources in the data processing environment at a first time, the second DLA book including a second set of objects constructed according to the CDM specification to represent a second set of corresponding instances of the resources in the data processing environment at a second time;
creating, responsive to the comparing, a DLA delta book, the DLA delta book including a difference between the first DLA book and the second DLA book; and
combining the DLA delta book with the first DLA book stored in the data repository to update the first DLA book.

2. The method of claim 1, wherein the difference between the first DLA book and the second DLA book is a difference in an attribute of a first object in the first set and a second object in the second set.

3. The method of claim 2, wherein the second object is selected for updating the first object because the first object includes a first instance identifier for the corresponding instance of a resource, and the second object also includes the first instance identifier.

4. The method of claim 3, further comprising:
omitting the first object in the first set and the second object in the second set for updating the first DLA book.

5. The method of claim 2, wherein the second object is selected for updating the first object because the first and the second objects include a matching type, and because the first and the second objects further include an identifier formed using a common naming rule.

6. The method of claim 1, wherein the difference between the first DLA book and the second DLA book is a third object in the first set that is absent in the second set, further comprising:
marking the third object for deletion in the DLA delta book.

7. The method of claim 1, wherein the difference between the first DLA book and the second DLA book is a fourth object in the second set that is absent in the first set, further comprising:
marking the fourth object for addition in the DLA delta book.

8. The method of claim 1, wherein the DLA book is the first DLA book, further comprising:
receiving at the application the first and the second DLA books, the second DLA book being a later version of the first DLA book, the first DLA book representing a first snapshot of the data processing environment at the first time, and the second DLA book representing a second snapshot of the data processing environment at the second time.

9. A computer usable program product comprising a computer usable storage medium including computer usable code for updating a Discovery Library Adapter (DLA) book in a data processing environment, the computer usable code comprising:
computer usable code for comparing at an application executing using a processor and a memory, a first DLA book and a second DLA book, the first DLA book being stored in a data repository and including a first set of objects constructed according to a Common Data Model (CDM) specification to represent a first set of corresponding instances of resources in the data processing environment at a first time, the second DLA book including a second set of objects constructed according to the CDM specification to represent a second set of corresponding instances of the resources in the data processing environment at a second time;
computer usable code for creating, responsive to the comparing, a DLA delta book, the DLA delta book including a difference between the first DLA book and the second DLA book; and
computer usable code for combining the DLA delta book with the first DLA book stored in the data repository to update the first DLA book.

10. The computer usable program product of claim 9, wherein the difference between the first DLA book and the second DLA book is a difference in an attribute of a first object in the first set and a second object in the second set.

11. The computer usable program product of claim 10, wherein the second object is selected for updating the first object because the first object includes a first instance identifier for the corresponding instance of a resource, and the second object also includes the first instance identifier.

12. The computer usable program product of claim 11, further comprising:
computer usable code for omitting the first object in the first set and the second object in the second set for updating the first DLA book.

13. The computer usable program product of claim 10, wherein the second object is selected for updating the first object because the first and the second objects include a matching type, and because the first and the second objects further include an identifier formed using a common naming rule.

14. The computer usable program product of claim 9, wherein the difference between the first DLA book and the second DLA book is a third object in the first set that is absent in the second set, further comprising:
computer usable code for marking the third object for deletion in the DLA delta book.

15. The computer usable program product of claim 9, wherein the difference between the first DLA book and the second DLA book is a fourth object in the second set that is absent in the first set, further comprising:
computer usable code for marking the fourth object for addition in the DLA delta book.

16. The computer usable program product of claim 9, wherein the DLA book is the first DLA book, further comprising:
computer usable code for receiving at the application the first and the second DLA books, the second DLA book being a later version of the first DLA book, the first DLA book representing a first snapshot of the data processing environment at the first time, and the second DLA book representing a second snapshot of the data processing environment at the second time.

17. The computer usable program product of claim 9, wherein the computer usable code is stored in a computer readable storage medium in a data processing system, and wherein the computer usable code is transferred over a network from a remote data processing system.

18. The computer usable program product of claim 9, wherein the computer usable code is stored in a computer readable storage medium in a server data processing system, and wherein the computer usable code is downloaded over a network to a remote data processing system for use in a computer readable storage medium associated with the remote data processing system.

19. A data processing system for updating a Discovery Library Adapter (DLA) book in a data processing environment, the data processing system comprising:
a storage device including a storage medium, wherein the storage device stores computer usable program code; and
a processor, wherein the processor executes the computer usable program code, and wherein the computer usable program code comprises:
computer usable code for comparing at an application executing using a processor and a memory, a first DLA book and a second DLA book, the first DLA book being stored in a data repository and including a first set of objects constructed according to a Common Data Model (CDM) specification to represent a first set of corresponding instances of resources in the data processing environment at a first time, the second DLA book including a second set of objects constructed according to the CDM specification to represent a second set of corresponding instances of the resources in the data processing environment at a second time;
computer usable code for creating, responsive to the comparing, a DLA delta book, the DLA delta book including a difference between the first DLA book and the second DLA book; and
computer usable code for combining the DLA delta book with the first DLA book stored in the data repository to update the first DLA book.

20. The data processing system of claim 19, wherein the difference between the first DLA book and the second DLA book is a difference in an attribute of a first object in the first set and a second object in the second set.
